(19) United States
(12) Patent Application Publication
(10) Pub. No.: US 2015/0025229 A1
(43) Pub. Date: Jan. 22, 2015

(54) PROCESS FOR SEPARATING BIOMASS COMPONENTS

(71) Applicant: NAGARJUNA ENERGY PRIVATE LIMITED, Hyedrabad (IN)

(72) Inventors: Dinakaran Samuel SUDHAKARAN, Hyedrabad (IN); Suresh Chandra SRIVASTAVA, Hyedrabad (IN); Manoj Kumar SARKAR, Hyedrabad (IN); Banibrata PANDEY, Hyedrabad (IN); Sakthi Priya PECHIMUTHU, Hyedrabad (IN)

(73) Assignee: NAGARJUNA ENERGY PRIVATE LIMITED, Hyedrabad (IN)

(21) Appl. No.: 14/183,007

(22) Filed: Feb. 18, 2014

Related U.S. Application Data
(63) Continuation of application No. 12/665,860, filed on Aug. 30, 2010, now abandoned.

(30) Foreign Application Priority Data
Jun. 20, 2007 (IN) 2376/CHE/2006

(51) Int. Cl. C08B 37/00; C07G 1/00

(52) U.S. Cl. CPC C08B 37/0003; C07G 1/00
USPC 530/500; 536/56; 422/187

(57) ABSTRACT

The present invention provides a process and System for Separation of biomass components into individual components such as cellulose, hemicellulose and lignin. The present invention provides a process for separating lignin in its native form. The cellulose obtained by the process of the present invention is highly reactive for saccharification.

### FIELD OF INVENTION

The present invention relates to a process of separation of biomass into individual components such as cellulose, hemi-cellulose and lignin.

### BACKGROUND OF INVENTION

Lignocellulosic biomass must be pre-treated to realize high yields vital to commercial success in biological conversion. Better pre-treatment can reduce use of expensive enzymes thus makes the process economically viable. Thus, more attention must be given to gaining insight into interactions among these operations and applying that insight to advance biomass conversion technologies that reduce costs. Although many biological, chemical, and physical methods have been tried over the years, pre-treatment advances are still needed for overall costs to become competitive with conventional commodity fuels and chemicals.

Paper industries have standardized an alkaline pulping process for preparation of cellulose. There are pulping equipments that can run in continuous operations as well. The pulping liquor used contains a very high percentage of alkali (NaOH) along with other chemicals. There are several problems with this approach because the process is not eco-friendly and the recovery of the alkali after treatment, is very expensive. The pulping liquor damages the hemicellulose and results in the formation of sugar degradation products. The recovery of lignin from the black liquor requires acidification, which adds to the cost. The lignin recovered is also degraded and is therefore not in its native form. The process also results in some cellulose loss. Therefore, this pulping process cannot be used for the bio-refinery platform.

Of late, there is a renewed interest in ammonia pretreatment besides other known pretreatment process.

US patent application US 2008/0008783A1, by Bruce Dale et al. provides a pretreatment process using concentrated ammonium hydroxide under pressure to improve the accessibility/digestibility of the polysaccharides from a cellulosic biomass. It also uses a combination of anhydrous ammonia and concentrated ammonium hydroxide solutions.

US patent application US 2007/0031918A1, by Dunson et al. provides a process in which the biomass at relatively high concentration treated with relatively low concentration of ammonia relative to the dry weight of the biomass. The ammonia treated biomass then digested with a saccharification enzyme to produce fermentable sugars. The process utilizes vacuum for better ammonia penetration and recovery, it also uses a plasticizer for softening.

U.S. Pat. No. 5,473,061 to Bredereck et al. (1995) describes a process which involves bringing the cellulose in contact with liquid ammonia at a pressure higher than atmospheric pressure in a pressure vessel and subsequent expansion by rapid reduction of the pressure to atmospheric pressure to activate the cellulose for subsequent chemical reactions.

Dale in U.S. Pat. Nos. 4,600,590 and 5,037,663 describes the use of various volatile chemical agents to treat the cellulose containing materials, particularly ammonia by what came to known as the AFEX process (ammonia freeze or ammonia fiber explosion).

U.S. Pat. No. 5,171,592 to Holtzapple et al. (1992) provides an AFEX process in which the biomass is treated with liquid ammonia or any other appropriate swelling agent, exploded and the swelling agent and the treated biomass are recovered.

U.S. Pat. No. 5,366,588 uses two stages to hydrolyze the hemicellulose sugars and the cellulosic sugars in a countercurrent process were using a batch reactor, and results in poor yield of glucose and xylose using a mineral acid. Further, the process scheme is complicated and the economic potential in large scale to produce inexpensive sugars for fermentation is low.

U.S. Pat. No. 5,188,673 employs concentrated acid hydrolysis, which has benefits of high conversion of biomass, but suffers from low product yields due to degradation and the requirement of acid recovery and recycle. Sulphuric acid concentrations used are 30-70 weight percent at temperatures less than 100° C.

Elian et al. U.S. Pat. No. 2,734,836 discloses a process where acid used to pretreat lignocellulosic material to extract pentoses using acetic acid. The material is sprinkled with the acid and heated to 80-120° C. and the acid is recycles through the cooker in a mariner to preserve the cellulose fibers. The residual material is used in conventional pulping.

Eickemeyer U.S. Pat. No. 3,787,241 discloses a percolator vessel for decomposing portions of wood. The first stage is the hydrolysis of hemicellulose to xylose using 1% sulphuric acid and then acid hydrolysis of cellulose occurs and lignin remains in the reactor throughout the hydrolysis and removed at the end.

Wright U.S. Pat. No. 4,615,742 discloses a series of hydrolysis reactors. Some of these are prehydrolysis reactors and are for removing hemicellulose while others are for hydrolysis. Because the contents move in a series, the duration of each step is the same. The process does not remove lignin from the solids and multiple reactors are required.

### OBJECTS OF THE PRESENT INVENTION

The main object of the present invention is to provide a process for process for separating biomass components such as cellulose, hemicellulose and lignin.

Another object of the present invention is to reduce the treatment time and eliminate the formation of sugar degradation products like furfurals.

One more object of the present invention is to provide a process to hydrolyze hemicellulose in the lignocellulosic material to pentose sugars.

### SUMMARY OF INVENTION

The present invention provides a process for separating lignocellulosic biomass derived from various sources like sweet sorghum bagasse, rice straw, wheat straw, sugar cane bagasse, corn stover, miscanthus, switch grass and various agricultural residues into its major components namely cellulose, hemicellulose and lignin in a specially designed pretreatment set up. The said process comprises of the following steps, (i) contacting the biomass such as herein described with an alkaline agent capable of dissolving essentially lignin in said biomass under predetermined temperature and pressure to dissolve and remove lignin; (ii) reacting with mild acid under predetermined temperature and pressure with the remaining residue of step (i) to hydrolyze hemicellulose and subsequently removing from the biomass; (iii) the residual solid should contain reactive cellulose with minimum impurities of hemicellulose and lignin in its native form.

### BRIEF DESCRIPTION OF DRAWINGS

FIG. 1 is an exemplary illustration of the system of separating biomass components according to an embodiment of the present invention.

### DETAILED DESCRIPTION OF THE INVENTION

Accordingly, the present invention provides a process for separating biomass components namely cellulose, hemicellulose and lignin, said process comprising steps
a) contacting biomass with an alkaline agent capable of dissolving essentially lignin in said biomass under predetermined temperature and pressure to dissolve and remove lignin under pressure in ammonia solution;
b) reacting with mild acid under predetermined temperature and pressure with the remaining residue of step (a) to hydrolyze hemicellulose and subsequently removing the same from biomass
c) obtaining highly reactive cellulose from the remaining biomass.

In an aspect of the present invention, the alkaline agent selected from the group comprising ammonia and ammonia derivatives such as amines.

In another aspect of the present invention the alkaline agent is contacted with the biomass at a temperature in the range of 90° C. to 200° C.

In still another aspect of the present invention, the predetermined pressure is in the range of 7.5-25 Bar.

In yet another aspect of the present invention the alkaline agent contacted with the biomass for a period of 1 to 30 minutes and preferably, the alkaline agent contacted with the biomass for a period of 5 to 10 minutes.

In a further aspect of the present invention, concentration of aqueous ammonia is in the range of 10% to 30%.

In still another aspect of the present invention, the dissolved lignin is separated under pressure in ammonia solution.

In yet another aspect of the present invention the mild acid selected from a group comprising mineral acids having concentration in the range of 0.25%-2%.

In another aspect of the present invention, the mild acid is reacted with the residua biomass at a temperature in the range of 120°-200° C.

In still another aspect of the present invention the mild acid is reacted with the residual bio mass at a pressure in the range of 1.5-20 Bar.

In yet another aspect of the present invention the mild acid is reacted with the residual biomass for a period of up to 15 min.

In a further aspect of the present invention, the hemicellulose is obtained in the form of pentose sugars.

In a further more aspect of the present invention, the lignin is present in its native form.

In another advantageous aspect of the present invention, formation of sugar degradation product is substantially eliminated.

In still another aspect of the present invention, the residue obtained is amenable for enzymatic saccharification.

The present invention also provides a system for separating biomass comprising:
(a) a reactor chamber for containing biomass having at least one inlet and at least one outlet;
(b) at least one cylinder for storing alkaline agent; said cylinder is in fluid flow communication with the inlet of the reactor chamber for supplying alkaline agent to the reactor chamber for dissolving lignin;
(c) a reservoir suitable for containing water and/or mild acid; said reservoir is in fluid flow communication with the inlet of the reactor chamber for supplying water and/or acid to reactor chamber to hydrolyze hemicellulose;
(d) A receiver coupled to the outlet of the reactor chamber for receiving dissolved lignin or hydrolyzed hemicellulose from the reactor chamber;
wherein the flow connections between the inlet of the reactor chamber and bank cylinder, reservoir and boiler adapted to operate in tandem,

In another embodiment of the present invention, a boiler is in fluid flow communication with the inlet of the reactor chamber for supplying steam to the reactor chamber.

In still another embodiment of the present invention, the receiver is in fluid flow communication with the boiler.

In yet another embodiment of the present invention comprising an ammonia absorption system comprising of a surge tank, hydrocyclone and two absorbers to recover and recycle ammonia.

According to a preferred embodiment, the present invention relates to a process in which the lignocellulosic biomass subjected to a two-stage treatment process
(i) ammonia treatment in which most of the lignin present in the biomass is dissolved and removed by a under pressure filtration process;
(ii) acid treatment of the residue obtained from the first step to hydrolyze most of the hemicellulose in the biomass as pentose sugars without the formation of sugar degradation products and obtain a residue containing mostly cellulose, which is highly reactive

The process of the present invention utilizes lignocellulosic biomass such as sweet sorghum bagasse, rice straw, wheat straw, sugar cane bagasse, corn stover, miscanthus, switch grass and various agricultural residues. Preferably, the materials comminuted into particles before treatment.

Following table discloses a typical biomass composition.

Typical biomass composition

| Biomass type | Cellulose % | Hemicellulose % | Lignin % |
|---|---|---|---|
| Sweet sorghum | 41.10% | 25.91% | 20.27% |
| bagasse | | | |
| Rice straw | 36.25% | 17.67% | 28.80% |
| Maize stalks | 35.65% | 19.87% | 22.25% |

In the process of the present invention, the biomass treated with alkaline agent under predetermined temperature and pressure to dissolve lignin under pressure. The alkaline agent can be any suitable alkaline agent capable of dissolving lignin. Alkaline agent such as ammonia or ammonia derivatives such as amines. Alkaline agent treated with biomass at a temperature in the range of 90 to 200° C. and at a pressure in the range of 7.5 to 25 Bar. The treatment time of biomass by alkaline agent is in the range of 1 to 30 minutes. Preferably, the treatment time of biomass by alkaline agent is in the range of 5 to 10 minutes. In a preferred embodiment of the present invention, aqueous ammonia can be used as an alkaline agent in a concentration in the range of 10 to 30%. Under high temperature and pressure, lignin of the biomass dissolves in alkaline agent. Thereafter, the alkaline agent filtered under high pressure by high-pressure filtration process.

The residual biomass obtained after alkaline agent treatment or ammonia treatment is reacted with mild acid or water at a predetermined temperature and pressure. Mild acid or water hydrolyzes the hemicellulose. Water or any type of mineral acid can be used for hydrolyzing hemicellulose. Preferably the mineral acids having concentration in the range of 0.25%-2% can be used. The residual biomass can be treated with mild acid at a temperature in the range of 120°-200° C. and at a pressure in the range of 1.5-20 Bar. The biomass can be treated with acid for a period in the range of 1 to 30 minutes and preferably in the range of 10 to 15 minutes. Majority of the hemicellulose hydrolyzed into pentose sugars:

one of the advantageous aspect of the invention, the cellulose thus obtained is highly reactive for enzymatic saccharification.

In conventional ammonia treatment process as described in the prior art, the lignocellulosic biomass treated with high/low concentrations of aqueous or anhydrous ammonia under high pressure and then pressure is released rapidly (explosion) to obtain a residue that is highly reactive. The lignin in these processes is re-precipitated in the biomass and is not separated. Whereas, in a preferred embodiment of the present invention, lignocellulosic biomass treated with aqueous ammonia under high pressure and the lignin dissolved in the process separated by a unique under pressure filtration process along with the ammonia solution; thereby re-precipitation of lignin is avoided.

According to an embodiment of the present invention, the lignocellulosic material treated with aqueous ammonia with a concentration of at least 10% and preferably 30%. The reaction temperature for the ammonia treatment can be between 90°-200° C. and preferably, 120° C. The pressure during the ammonia treatment is between 7.5 Bar to 22 Bar however pressure of 15 Bar is preferable.

The lignocellulosic biomass taken in the reactor and ammonia solution added to give a solid concentration of preferable 15% and heated to the required condition by direct steam injection from the boiler. After holding for preferably 10 min in the desired condition the ammonia solution filtered under pressure, which contains dissolved lignin, the remaining residue consists of mostly cellulose and hemicellulose. When the ammonia in the solution recovered using the ammonia absorption system the lignin precipitates.

The lignin obtained during the ammonia treatment by under pressure filtration process has very little modifications. In other words the lignin thus obtained exists in its native form.

The conventional process for the hydrolysis of hemicellulose utilized either concentrated acid treatment or mild acid treatment at high temperatures. These processes result in the formation of sugar degradation products. In the present process, the residue obtained after step one, subjected mild acid treatment at high temperatures for short time to hydrolyze most of the hemicellulose in the residue to pentose sugar with minimal formation of degradation products.

The process of the present invention utilizes aqueous solution of acid (sulphuric acid, hydrochloric acid or nitric acid or any other strong acid, which can give a pH of 2) for the hydrolysis of hemicellulose. Sulphuric acid is preferred, and when sulphuric acid used as the acid catalyst the concentration of acid is between 0.25%-2%, usually 1% acid concentration is preferred.

The residue obtained after step 1 (ammonia treatment) is added with preferable 1% sulphuric acid and heated to a temperature of 120°-200° C., preferably 145° C. by live steam injection. The contents maintained at the said condition for 10-30 minutes; however the preferred time is 15 min. After the holding time the contents filtered under pressure to get a residue rich in highly reactive cellulose and a filtrate that contains mostly hemicellulose as pentose sugars. The unique under pressure filtration process helps in rapid cooling and thereby reducing the formation of sugar degradation products.

The pretreated material obtained after the unique two-stage pretreatment process of the present invention is rich in reactive cellulose, which is evident from its susceptibility to enzymatic saccharification.

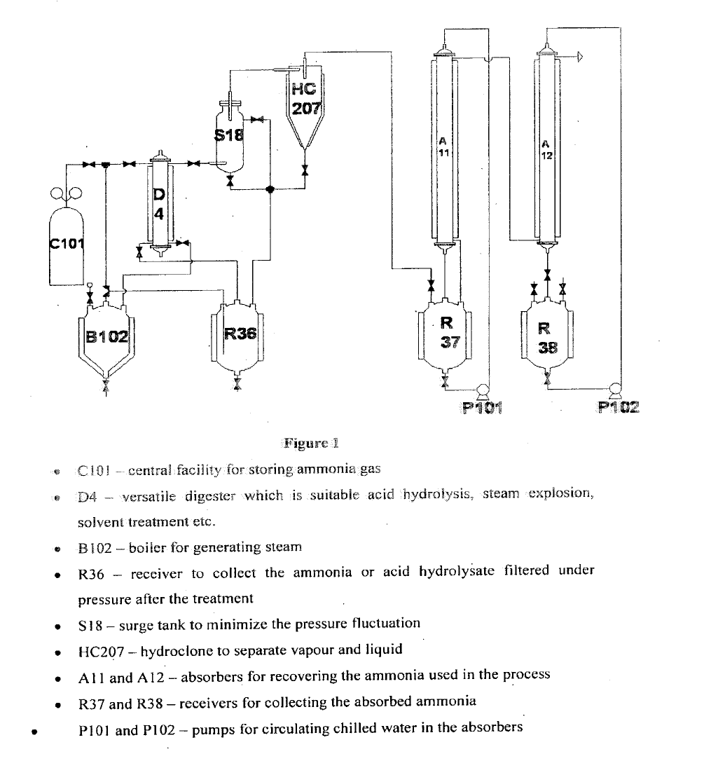

The following paragraphs describe a reactor system of the present invention with reference to FIG. 1.

As can be observe from FIG. 1, the system of separating biomass components of the present invention comprises a reactor chamber. Said reactor chamber can be a versatile digester (D4) which is suitable for acid hydrolysis, steam explosion, solvent treatment etc. Biomass, which is to be treated, kept in the reactor chamber or versatile digester. The reactor chamber has at least one inlet and at least one outlet. The inlet of the reactor chamber is in fluid flow communication with a cylinder in which alkaline agent is being stored. More than one cylinder can be used for storing the alkaline agent, The facility of storing the alkaline agent depicted in FIG. 1 as a central facility for storing ammonia gas (C101). This facility used for supplying alkaline agent in the reactor chamber.

Further, the reactor chamber provided with an inlet for supplying water and/or mild acid into the reactor chamber. A separate reservoir or storage facility (not shown in the figure) can be provided for storing water and/or mild acid. Said reservoir is in fluid flow communication with an inlet of the reactor chamber for supplying water and/or mild acid in the reactor chamber to hydrolyze hemicellulose. A boiler (102) coupled to an inlet of the reactor chamber for supplying steam at a predetermined temperature and pressure. For collecting the dissolved lignin and/or hydrolyzed hemicellulose from the reactor chamber a receiver provided. Said receiver coupled to the outlet of the reactor chamber.

If ammonia is used as an alkaline agent in the present process, then an ammonia absorption system can be provide to recover and recycle ammonia. The ammonia absorption system comprises a surge tank, hydro-cyclone and two absorbers.

### EXAMPLES

### Example 1

### Effect of Different Ammonia Concentrations on Sweet Sorghum Bagasse with Increased Treatment Time

About 100 g sweet sorghum bagasse was loaded in the pre-treatment reactor. The particle size of the bagasse used was in the range of 0.5-1 mm. To this biomass different concentration of ammonia either 10% or 20% or 30% were added. The amount of different ammonia solutions added was such as to give a final solid concentration of 15%. The reactor then heated to attain of pressure of 7.5 Bar in all the cases. The temperatures attained for 10, 20 and 30% ammonia were 140, 120 and 90 ° C. respectively. Direct steam injection employed to heat the reactor. The contents in the reactor held at the said conditions for an extended time of 30 min. After the holding time the contents filtered under pressure and the hydrolysate collected in a receiver. The hydrolysates/filtrates analyzed for cellulose and hemicellulose present by sugar analysis. The residue obtained analyzed for cellulose, hemicellulose and lignin. The results is given in table 3.

Table 1 gives the percentage (%) removal of cellulose, hemicellulose and lignin in the different pretreated residues when compared to the starting material.

TABLE 1

| Ammonia | Pressure | Temperature | % removal of biomass components | | |
|---|---|---|---|---|---|
| concentration | (bar) | ° C. | Cellulose | Hemicellulose | Lignin |
| 10% | 7.5 | 140 | 17.73% | 15.54% | 42.48% |
| | 11 | 160 | 20.45% | 19.67% | 55.84% |
| | 15 | 180 | 25.41% | 22.96% | 58.59% |
| 20% | 7.5 | 120 | 24.71% | 16.71% | 43.53% |
| | 10 | 126 | 20.28% | 14.29% | 45.66% |
| | 15 | 145 | 19.78% | 28.50% | 61.67% |
| | 20 | 160 | 29.84% | 44.29% | 69.80% |
| 30% | 7.5 | 90 | 19.17 | 10.77 | 37.59 |
| | 15 | 120 | 18.85 | 39.91 | 60.90 |
| | 22 | 140 | 22.44 | 47.99 | 76.07 |

### Example 2

### Sulphuric Acid Treatment at Higher Temperatures

The biomass (100 g), sweet sorghum bagasse of 0.5-1 mm particle size, was loaded in the pre-treatment reactor to this 1% (v/v) sulphuric acid was added to get a final concentration of 15%. The contents in the reactor heated to 140° C. or 160° C. using direct steam injection. The contents held at the said temperatures for 10 min. After that, the contents filtered under pressure to get the acid hydrolysate and residue. The hydrolysates/filtrates analyzed for cellulose and hemicellulose present by sugar analysis. The residue obtained analyzed fix cellulose, hemicellulose and lignin. The results are given in table 2.

Table 2 gives the % removal of cellulose, hemicellulose and lignin in the pretreated residues when compared to the starting material.

TABLE 2

| | % removal of biomass components | | |
|---|---|---|---|
| Temperature | Cellulose | Hemicellulose | Lignin |
| 140° C. | 35.56% | 59.30% | 21.40% |
| 160° C. | 32.24% | 81.19% | 29.20% |

### Example 3

### Two-Stage Process for the Separation of Biomass Components

In the pre-treatment reactor 100 g of sweet sorghum bagasse of size 0.5-1 mm was loaded. To this 30% ammonia solution added to give a final solid concentration of 15%. The contents of the reactor then heated to achieve a temperature of 120° C. (the corresponding pressure at that temperature was 15 Bar) by direct steam injection. The contents held at that temperature for 10 min and then filtered under pressure. The hydrolysate collected in the receiver.

After the under pressure filtration process the residue was washed with steam to remove the residual ammonia and then the reactor was cooled by passing cold water in the jacket. After cooling the reactor, 1% sulphuric acid pumped in to achieve a solid concentration of 15%. The contents heated to 140° C. or 160° C. by direct steam injection. The contents held at the said temperature for 10 min and then filtered under pressure. The acid hydrolysate collected separately.

The hydrolysates/filtrates analyzed for cellulose and hemicellulose present by sugar analysis. The residue obtained analyzed for cellulose, hemicellulose and lignin. The results are given in table 3.

Table 3 gives the percentage (%) removal of cellulose, hemicellulose and lignin in the pretreated residues when compared to the starting material.

TABLE 3

| | | % removal of |
|---|---|---|
| | | biomass |
| Condition | Biomass component | components |
| Ammonia- | Cellulose | 24.96% |
| Acid | Hemicellulose | 68.05% |
| (140° C.) | Lignin | 64.89% |
| Ammonia- | Cellulose | 22.22% |
| Acid | Hemicellulose | 81.02% |
| (160° C.) | Lignin | 67.88% |

### Example 4

### Two-Stage Process for the Separation of Biomass Components at Higher Scale

In the pre-treatment reactor 1000 g of sweet sorghum bagasse of size 0.5-1 mm was loaded. To this 30% ammonia solution added to give a final solid concentration of 15%. The contents of the reactor then heated to achieve a temperature of 120° C. (the corresponding pressure at that temperature was 15 Bar) by direct steam injection. The contents held at that temperature for 10 min and then filtered under pressure. The hydrolysate collected in the receiver.

After the under pressure filtration process the residue was washed with steam to remove the residual ammonia and then the reactor was cooled by passing cold water in the jacket. After cooling the reactor, 1% sulphuric acid pumped in to achieve a solid concentration of 15%. The contents then heated to 140° C. by direct steam injection. The contents held at the said temperature for 15 min and then filtered under pressure. The acid hydrolysate collected separately.

The hydrolysate/filtrates analyzed for cellulose and hemicellulose present by sugar analysis. The residue obtained analyzed for cellulose, hemicellulose and lignin. The result is, given in table 4.

Table 4 gives the percentage (%) removal of cellulose, hemicellulose and lignin in the pretreated residues when compared to the starting material.

TABLE 4

| | % removal of biomass |
|---|---|
| Biomass component | components |
| Cellulose | 12.12% |
| Hemicellulose | 79.73% |
| Lignin | 79.32% |

### Example 5

### Susceptibility of Pretreated Residue to Enzymatic Saccharification

The final pretreated residue obtained after the two stage pretreatment process in example 6 digested with the enzyme commercial cellulose enzyme preparation to check the susceptibility of the residue for enzymatic saccharification. A 10% slurry was prepared and to this 60 FPU/g of the enzyme was loaded. The contents incubated at 50° C. at a pH of 4.5 for a period of 24 hrs. After the incubation time the sugars were to estimate the saccharification percentage. There was 85.3% saccharification in 24hrs, which clearly indicates the susceptibility of the pretreated residue to the cellulose enzyme.

Advantages of the present invention:
1. The process of the present invention ammonia treatment will not use explosive steps so the ammonia recovery will be very easy.
2. The process of the present invention separates all the ingredients like cellulose, hemi-cellulose and lignin at a time and converts hemi-cellulose to pentose sugar.
3. The process of the present invention does not require supercritical ammonia.
4. Process of the present invention separates all three ingredients such as lignin, cellulose and pentose sugars with high purity.
5. There is no loss in quality of ingredients in the process of the present invention.
6. In the process of the present invention, formation of sugar degrading products is minimal.
7. The alkaline agent solution used in the process of the present invention can be recovered very easily.
8. The alkaline agent solution used in the process of the present invention is responsible for the separation of the lignin resulting in high purity cellulose.
9. Lignin recovered by the process of the present invention is of very high purity and there is no re-deposition because the dissolved lignin removed under pressure.
10. In the present invention, lignin removed without affecting the other biomass components.
11. Cellulose obtained in the present invention is very reactive.

1-11. (canceled)

12. A process for separating biomass components namely cellulose, hemicellulose and lignin, said process comprising steps:
a) contacting biomass with an alkaline agent capable of dissolving essentially lignin in said biomass under a first predetermined temperature and a first pressure to dissolve lignin;
b) removing the lignin under pressure;
c) reacting mild acid or water under a second predetermined temperature and a second pressure with the remaining residue of step (a) to hydrolyze hemicellulose and subsequently removing the same from biomass;
d) obtaining cellulose from the remaining biomass.

13. A process as claimed in claim 12, wherein the alkaline agent is selected from the group comprising ammonia or derivatives thereof.

14. A process as claimed in claim 12, wherein the alkaline agent is contacted with the biomass at a temperature in the range of 90° to 200° C. and at a pressure in the range of 7.5-25 Bar.

15. A process as claimed in claim 12, wherein the alkaline agent is contacted with the biomass for a period in the range of 1 to 30 minutes.

16. A process as claimed in claim 13, wherein the concentration of ammonia is in the range of 10% to 30%.

17. A process as claimed in claim 12, wherein the mild acid is selected from a group comprising mineral acids having a concentration of 0.25% to 2%.

18. A process as claimed in claim 12, wherein the mild acid is reacted with the residual biomass at a temperature in the range of 120°-200° C. and at a pressure in the range of 1.5-20 Bar.

19. A system for separating biomass comprising:
(a) a reactor chamber for containing biomass having at least one inlet and at least one outlet;
(b) at least one cylinder for storing alkaline agent, said cylinder is in fluid flow communication with the inlet of the reactor chamber for supplying alkaline agent to the reactor chamber for dissolving lignin;
(c) a reservoir suitable for containing water and/or mild acid, said reservoir is in fluid flow communication with the inlet of the reactor chamber for supplying water and/or acid to reactor chamber to hydrolyze hemicellulose;
(d) a receiver coupled to the outlet of the reactor chamber for receiving dissolved lignin or hydrolyzed hemicellulose from the reactor chamber; wherein the flow connections between the inlet of the reactor chamber and bank cylinder, reservoir and boiler are adapted to operate in tandem.

20. A system as claimed in claim 19, wherein a boiler is in fluid flow communication with the inlet of the reactor chamber for supplying steam to the reactor chamber.

21. A system as claimed in claim 19, wherein the receiver is in fluid flow communication with the boiler.

22. A system as claimed in claim 19, comprising an ammonia absorption system comprising a surge tank, hydrocyclone and two absorbers to recover and recycle ammonia.

23. A process as claimed in claim 12, wherein step (b) comprises pressure filtration.
